(19) United States
(12) Patent Application Publication
(10) Pub. No.: US 2023/0239088 A1
(43) Pub. Date: Jul. 27, 2023

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/010,957

(22) PCT Filed: Jun. 18, 2020
(86) PCT No.: PCT/CN2020/096700

§ 371 Date: Dec. 16, 2022

(51) Int. Cl. H04L 5/00

(52) U.S. Cl. CPC H04L 5/0012; H04L 5/0051

(57) ABSTRACT

Embodiments of the present disclosure relate to methods, devices and computer storage media for communication. A method comprises transmitting, from a network device, Sounding Reference Signal (SRS) hopping parameters and a partial sounding parameter to a terminal device, wherein the SRS hopping parameters indicate a bandwidth configuration for SRS communication and the partial sounding parameter indicates whether partial sounding across frequency is enabled or not; and receiving SRS sequences from the terminal device based on the SRS hopping parameters and the partial sounding parameter. Embodiments of the present disclosure can achieve flexible partial sounding across frequency.

### TECHNICAL FIELD

Embodiments of the present disclosure generally relate to the field of telecommunication, and in particular, to methods, devices and computer storage media for communication.

### BACKGROUND

In the 3GPP meeting RAN#86, enhancements on Sounding Reference Signal (SRS) have been discussed. For example, it has been proposed to identify and specify enhancements on aperiodic SRS triggering to facilitate more flexible triggering and/or Downlink Control Information (DCI) overhead/usage reduction. It has also been proposed to specify SRS switching for up to 8 antennas. Moreover, it has been proposed to evaluate and specify the following mechanism(s) to enhance SRS capacity and/or coverage: SRS time bundling, increased SRS repetition, partial sounding across frequency.

However, no details about partial sounding across frequency have been specified. Moreover, according to the current SRS hopping structure as specified in the current specifications, sub-bands can only be sounded in several fixed orders, which is not flexible enough.

### SUMMARY

In general, example embodiments of the present disclosure provide methods, devices and computer storage media for communication.

In a first aspect, there is provided a method of communication. The method comprises transmitting, from a network device, Sounding Reference Signal (SRS) hopping parameters and a partial sounding parameter to a terminal device, wherein the SRS hopping parameters indicate a bandwidth configuration for SRS communication and the partial sounding parameter indicates whether partial sounding across frequency is enabled or not; and receiving SRS sequences from the terminal device based on the SRS hopping parameters and the partial sounding parameter.

In a second aspect, there is provided a method of communication. The method comprises receiving, at a terminal device and from a network device, Sounding Reference Signal (SRS) hopping parameters and a partial sounding parameter, wherein the SRS hopping parameters indicate a bandwidth configuration for SRS communication and the partial sounding parameter indicates whether partial sounding across frequency is enabled or not; and transmitting SRS sequences to the network device based on the SRS hopping parameters and the partial sounding parameter.

In a third aspect, there is provided a network device. The network device comprises a processor and a memory coupled to the processor. The memory stores instructions that when executed by the processor, cause the network device to perform actions. The actions comprise transmitting, to a terminal device, Sounding Reference Signal (SRS) hopping parameters and a partial sounding parameter, wherein the SRS hopping parameters indicate a bandwidth configuration for SRS communication and the partial sounding parameter indicates whether partial sounding across frequency is enabled or not; and receiving SRS sequences from the terminal device based on the SRS hopping parameters and the partial sounding parameter.

In a fourth aspect, there is provided a terminal device. The terminal device comprises a processor and a memory coupled to the processor. The memory stores instructions that when executed by the processor, cause the terminal device to perform actions. The actions comprise receiving, from a network device, Sounding Reference Signal (SRS) hopping parameters and a partial sounding parameter, wherein the SRS hopping parameters indicate a bandwidth configuration for SRS communication and the partial sounding parameter indicates whether partial sounding across frequency is enabled or not; and transmitting SRS sequences to the network device based on the SRS hopping parameters and the partial sounding parameter.

In a fifth aspect, there is provided a computer readable medium having instructions stored thereon. The instructions, when executed on at least one processor, cause the at least one processor to perform the method according to the above first or second aspect.

In a sixth aspect, there is provided a computer program product that is stored on a computer readable medium and includes machine-executable instructions. The machine-executable instructions, when being executed, cause a machine to perform the method according to the above first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrate an example communication network in which embodiments of the present disclosure can be implemented;

FIG. 2 illustrates an example process for SRS communication in accordance with some embodiments of the present disclosure;

FIG. 3 illustrates an example of partial sounding across frequency in accordance with some embodiments of the present disclosure;

FIGS. 4A-4D illustrate examples of partial sounding across frequency in accordance with some embodiments of the present disclosure;

FIGS. 5A-5C illustrate examples of partial sounding across frequency in accordance with some embodiments of the present disclosure;

FIGS. 6A-6D illustrate examples of partial sounding across frequency in accordance with some embodiments of the present disclosure;

FIGS. 7A-7B illustrate examples of partial sounding across frequency in accordance with some embodiments of the present disclosure;

FIGS. 8A-8G illustrate examples of partial sounding across frequency in accordance with some embodiments of the present disclosure;

FIGS. 9A-9B illustrate examples of partial sounding across frequency in accordance with some embodiments of the present disclosure;

FIG. 10 illustrates an example for configuring partial sounding across frequency in accordance with some embodiments of the present disclosure;

FIG. 11 illustrates an example for configuring two levels of periodicity for persistent or semi-persistent SRS in accordance with some embodiments of the present disclosure;

FIG. 12 illustrates a flowchart of an example method in accordance with some embodiments of the present disclosure;

FIG. 13 illustrates a flowchart of an example method in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As described above, in the 3GPP meeting RAN#86, enhancements on SRS have been discussed. For example, it has been proposed to identify and specify enhancements on aperiodic SRS triggering to facilitate more flexible triggering and/or DCI overhead/usage reduction. It has also been proposed to specify SRS switching for up to 8 antennas. Moreover, it has been proposed to evaluate and specify the following mechanism(s) to enhance SRS capacity and/or coverage: SRS time bundling, increased SRS repetition, partial sounding across frequency.

There are some possible approaches for the SRS coverage enhancement. For example, one possible solution is to allow a network device (for example, a next generation NodeB, gNB) to configure more flexible frequency locations for SRS. A terminal device (for example, user equipment, UE) can firstly transmit SRS with a subset of resource blocks (RBs) comprised in a sub-band, which is also referred to as “partial sounding” or “partial sounding across frequency”. After the network device measures all the sub-bands, it can configure a subset of the sub-bands to the terminal device. Then, the terminal device can transmit SRS with full RBs in the subset of the sub-bands. Such two-step sounding will reduce the frequency resources UE needs to sound in each SRS transmission, thus SRS coverage can be improved with power boosting.

However, no details about partial sounding across frequency have been specified. Moreover, according to the current SRS hopping structure as specified in the current specifications, sub-bands can only be sounded in several fixed orders, which is not flexible enough.

In Clause 6.2.1.1 of the 3GPP specification TS 38.214, regarding the SRS frequency hopping procedure, it is specified that for a given SRS resource, the UE is configured with repetition factor R ∈ {1,2,4} by higher layer parameter resourceMapping in SRS-Resource where R≤5Ns. When frequency hopping within an SRS resource in each slot is not configured (R=Nₛ), each of the antenna ports of the SRS resource in each slot is mapped in all the N ₛ symbols to the same set of subcarriers in the same set of PRBs. When frequency hopping within an SRS resource in each slot is configured without repetition (R=1), according to the SRS hopping parameters B_{SRS}, C_{SRS} and bₕₒₚ defined in Clause 6.4.1.4 of the 3GPP specification TS 38.211, each of the antenna ports of the SRS resource in each slot is mapped to different sets of subcarriers in each OFDM symbol, where the same transmission comb value is assumed for different sets of subcarriers. When both frequency hopping and repetition within an SRS resource in each slot are configured (Nₛ=4, R=2), each of the antenna ports of the SRS resource in each slot is mapped to the same set of subcarriers within each pair of R adjacent OFDM symbols, and frequency hopping across the two pairs is according to the SRS hopping parameters B_{SRS}, C_{SRS} and b_{hop.}

A UE may be configured Nₛ= 2 or 4 adjacent symbol aperiodic SRS resource with intra-slot frequency hopping within a bandwidth part, where the full hopping bandwidth is sounded with an equal-size sub-band across Nₛ symbols when frequency hopping is configured with R=1. A UE may be configured Nₛ = 4 adjacent symbols aperiodic SRS resource with intra-slot frequency hopping within a bandwidth part, where the full hopping bandwidth is sounded with an equal-size sub-band across two pairs of R adjacent OFDM symbols, when frequency hopping is configured with R=2. Each of the antenna ports of the SRS resource is mapped to the same set of subcarriers within each pair of R adjacent OFDM symbols of the resource.

A UE may be configured Nₛ = 1 symbol periodic or semi-persistent SRS resource with inter-slot hopping within a bandwidth part, where the SRS resource occupies the same symbol location in each slot. A UE may be configured Nₛ = 2 or 4 symbol periodic or semi-persistent SRS resource with intra-slot and inter-slot hopping within a bandwidth part, where the N-symbol SRS resource occupies the same symbol location(s) in each slot. For Nₛ=4, when frequency hopping is configured with R=2, intra-slot and inter-slot hopping is supported with each of the antenna ports of the SRS resource mapped to different sets of subcarriers across two pairs of R adjacent OFDM symbol(s) of the resource in each slot. Each of the antenna ports of the SRS resource is mapped to the same set of subcarriers within each pair of R adjacent OFDM symbols of the resource in each slot. For Nₛ= R, when frequency hopping is configured, inter-slot frequency hopping is supported with each of the antenna ports of the SRS resource mapped to the same set of subcarriers in R adjacent OFDM symbol(s) of the resource in each slot.

In Clause 6.4.1.4.3 of the 3GPP specification TS 38.211, regarding the SRS resource mapping to physical resources, it is specified that when SRS is transmitted on a given SRS resource, the sequence r^{(pi)}(n,l′) for each OFDM symbol l′ and for each of the antenna ports of the SRS resource shall be multiplied with the amplitude scaling factor β_{SRS} in order to conform to the transmit power specified in the 3GPP specification TS 38.213 and mapped in sequence starting with r^{(pi)}(0,l′)to resource elements (k,l) in a slot for each of the antenna ports Pi according to

$$\begin{matrix}{a}_{{K}_{T C} {k}^{′} + {k}_{0}^{\left({p}_{i}\right)} , {l}^{′} + {l}_{0}}^{\left({p}_{i}\right)} = \\ \left\{\begin{matrix}\frac{1}{\sqrt{{N}_{a p}}} {β}_{\text{SRS}} {r}^{\left({p}_{i}\right)} \left({k}^{′} , {l}^{′}\right) & {k}^{′} = 0 , 1 , … , {M}_{\text{sc,} b}^{\text{SRS}} - 1 {l}^{′} = 0 , 1 , … {N}_{\text{symb}}^{\text{SRS}} - 1 \\ 0 & \text{otherwise}\end{matrix}\right)\end{matrix}$$

The length of the sounding reference signal sequence is given by

$${M}_{\text{sc,} b}^{\text{SRS}} = {m}_{\text{SRS,} b} {N}_{\text{sc}}^{\text{RB}} / {K}_{\text{TC}}$$

where m_{SRS,b} is given by a selected row of Table 6.4.1.4.3-1 with b=B_{SRS} where B_{SRS} ∈ {0,1,2,3} is given by the field b-SRS contained in the higher-layer parameter freqHopping if configured, otherwise B_{SRS} = 0. The row of the table is selected according to the index C_{SRS} ∈ {0,1,...,63} given by the field c-SRS contained in the higher-layer parameter freqHopping.

The frequency-domain starting position

$${k}_{0}^{\left({p}_{i}\right)}$$

is defined by

$${k}_{0}^{\left({p}_{i}\right)} = {\overline{k}}_{0}^{\left({p}_{i}\right)} + {\sum }_{b = 0}^{{B}_{\text{SRS}}} {K}_{\text{TC}} {M}_{\text{sc,} b}^{\text{SRS}} {n}_{b}$$

where

$${\overline{k}}_{0}^{\left({p}_{i}\right)} = {n}_{\text{shift}} {N}_{\text{sc}}^{\text{RB}} + \left({k}_{\text{TC}}^{\left({p}_{i}\right)} + {k}_{\text{offset}}^{{l}^{′}}\right) \text{mod} {K}_{\text{TC}}$$

$$\begin{matrix}{k}_{\text{TC}}^{\left({p}_{i}\right)} = \\ \left\{\begin{matrix}\left({\overline{k}}_{\text{TC}} + {K}_{\text{TC}} / 2\right) mod {K}_{\text{TC}} & \text{if} {n}_{\text{SRS}}^{\text{cs}} ∈ \left\{{n}_{\text{SRS}}^{\text{cs,max}} / 2 , … , {n}_{\text{SRS}}^{\text{cs,max}} - 1\right\} \text{and} {N}_{\text{ap}}^{\text{SRS}} = 4 \text{and} {p}_{i} ∈ \left\{1001 , 1003\right\} \\ {\overline{k}}_{\text{TC}} & \text{otherwise}\end{matrix}\right)\end{matrix}$$

If

$${N}_{\text{BWP}}^{\text{start}} \leq n$$

shift the reference point for

$${k}_{0}^{\left({p}_{i}\right)} = 0$$

is subcarrier 0 in common resource block 0, otherwise the reference point is the lowest subcarrier of the BWP. If the SRS is configured by the IE [SRS-for-positioning], the quantity

$${k}_{\text{offset}}^{l ′}$$

is given by Table 6.4.1.4.3-2, otherwise

$${k}_{\text{offset}}^{{l}^{′}} = 0.$$

The frequency domain shift value n_{shift} adjusts the SRS allocation with respect to the reference point grid and is contained in the higher-layer parameter freqDomainShift in the SRS-Config IE or the [SRS-for-positioning] IE. The transmission comb offset k̅_{TC} ∈ {0,1, ...,K_{TC} – 1} is contained in the higher-layer parameter transmissionComb in the SRS-Config IE or the [SRS-for-positioning] IE and n_{b} is a frequency position index.

Frequency hopping of the sounding reference signal is configured by the parameter bₕₒₚ ∈ {0,1,2,3}, given by the field b-hop contained in the higher-layer parameter freqHopping if configured, otherwise bₕₒₚ = 0.

If bₕₒₚ ≥ B_{SRS}, frequency hopping is disabled and the frequency position index n_{b} remains constant (unless re-configured) and is defined by

$${n}_{\text{b}} = \left⌊4 {n}_{\text{RRC}} / {m}_{\text{SRS,} b}\right⌋ mod {N}_{\text{b}}$$

for all

$${N}_{\text{symb}}^{\text{SRS}}$$

OFDM symbols of the SRS resource. The quantity n_{RRC} is given by the higher-layer parameter freqDomainPosition if configured, otherwise n_{RRC} = 0, and the values of m_{SRS,b} and N_{b} for b = B_{SRS} are given by the selected row of Table 6.4.1.4.3-1 corresponding to the configured value of C_{SRS}.

If bₕₒₚ < B_{SRS}, frequency hopping is enabled and the frequency position indices n_{b} are defined by

$${n}_{b} = \left\{\begin{matrix}\left⌊4 {n}_{\text{RRC}} / {m}_{\text{SRS,} b}\right⌋ mod {N}_{\text{b}} & b \leq {b}_{\text{hop}} \\ \left({F}_{b} \left({n}_{\text{SRS}}\right) + \left⌊4 {n}_{\text{RRC}} / {m}_{\text{SRS,} b}\right⌋\right) mod {N}_{\text{b}} & \text{otherwise}\end{matrix}\right)$$

where N_{b} is given by Table 6.4.1.4.3-1,

$$\begin{matrix}{F}_{b} \left({n}_{\text{SRS}}\right) = \\ \left\{\begin{matrix}\left({N}_{b} / 2\right) \left⌊\frac{{n}_{\text{SRS}} mod {\prod }_{{b}^{′} = {b}_{\text{hop}}}^{b} {N}_{{b}^{′}}}{{\prod }_{{b}^{′} = {b}_{\text{hop}}}^{b - 1} {N}_{{b}^{′}}}\right⌋ + \left⌊\frac{{n}_{\text{SRS}} mod {\prod }_{{b}^{′} = {b}_{\text{hop}}}^{b} {N}_{{b}^{′}}}{2 {\prod }_{{b}^{′} = {b}_{\text{hop}}}^{b - 1} {N}_{{b}^{′}}}\right⌋ & \text{if} {N}_{b} \text{even} \\ \left⌊{N}_{b} / 2\right⌋ \left⌊{n}_{\text{SRS}} / {\prod }_{{b}^{′} = {b}_{\text{hop}}}^{b - 1} {N}_{{b}^{′}}\right⌋ & \text{if} {N}_{b} \text{odd}\end{matrix}\right)\end{matrix}$$

and where N_{bhop} = 1 regardless of the value of N_{b}. The quantity n_{SRS} counts the number of SRS transmissions. For the case of an SRS resource configured as aperiodic by the higher-layer parameter resourceType, it is given by n_{SRS} = l′/R within the slot in which the

$${N}_{\text{symb}}^{\text{SRS}}$$

symbol SRS resource is transmitted. The quantity

$$R \leq {N}_{\text{symb}}^{\text{SRS}}$$

is the repetition factor given by the field repetitionFactor contained in the higher-layer parameter resourceMapping if configured, otherwise

$$R = {N}_{\text{symb}}^{\text{SRS}}$$

For the case of an SRS resource configured as periodic or semi-persistent by the higher-layer parameter resourceType, the SRS counter is given by

$${n}_{\text{SRS}} = \left(\frac{{N}_{\text{slot}}^{\text{frame,} μ} {n}_{\text{f}} + {n}_{\text{s,f}}^{μ} - {T}_{\text{offset}}}{{T}_{\text{SRS}}}\right) ⋅ \left(\frac{{N}_{\text{symb}}^{\text{SRS}}}{\text{R}}\right) + \left⌊\frac{{l}^{′}}{R}\right⌋$$

for slots that satisfy

$$\left({N}_{\text{slot}}^{\text{frame,} μ} {n}_{\text{f}} + {n}_{\text{s,f}}^{μ} - {T}_{\text{offset}}\right) mod {T}_{\text{SRS}} = 0.$$

The periodicity T_{SRS} in slots and slot offset T_{offset} are given in clause 6.4.1.4.4 of the 3GPP specification TS 38.211.

Embodiments of the present disclosure provide a solution for partial sounding across frequency. According to this solution, SRS hopping parameters and a partial sounding parameter are transmitted from a network device to a terminal device. The SRS hopping parameters indicate a bandwidth configuration for SRS communication. The partial sounding parameter indicates whether partial sounding across frequency is enabled or not. SRS sequences are received from the terminal device based on the SRS hopping parameter and the partial sounding parameter. As such, embodiments of the present disclosure can achieve flexible partial sounding across frequency.

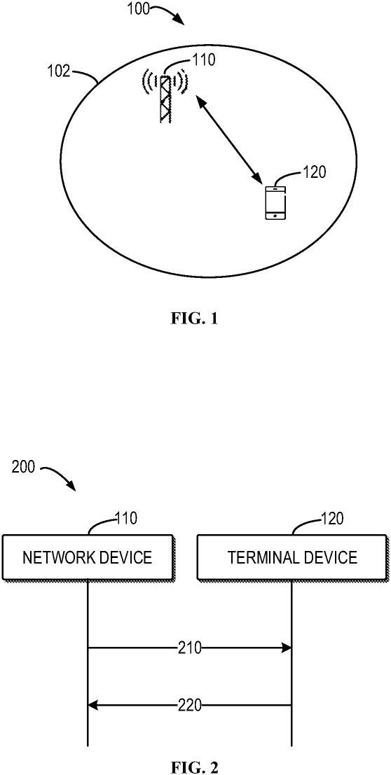

Principle and implementations of the present disclosure will be described in detail below with reference to FIGS. 1-14.

FIG. 1 shows an example communication network 100 in which implementations of the present disclosure can be implemented. The network 100 includes a network device 110 and a terminal device 120 served by the network device 110. The network 100 can provide at least one serving cell 102 to serve the terminal device 120. It is to be understood that the number of network devices, terminal devices and/or serving cells is only for the purpose of illustration without suggesting any limitations. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In addition to normal data communications, the network device 110 may send a RS to the terminal device 120 in a downlink. Similarly, the terminal device 120 may transmit a RS to the network device 110 in an uplink. Generally speaking, a RS is a signal sequence (also referred to as “RS sequence”) that is known by both the network device 110 and the terminal devices 120. For example, a RS sequence may be generated and transmitted by the network device 110 based on a certain rule and the terminal device 120 may deduce the RS sequence based on the same rule. For another example, a RS sequence may be generated and transmitted by the terminal device 120 based on a certain rule and the network device 110 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking, Positioning Reference Signal (PRS) and so on. For example, SRS can be used by the network device 110 to perform uplink channel estimation, so as to perform resource allocation and configure transmission parameters for UL transmission from the terminal device 120 based on the result of the uplink channel estimation.

In transmission of downlink and uplink RSs, the network device 110 may assign corresponding resources for the transmission and/or specify which RS sequence is to be transmitted. In some scenarios, both the network device 110 and the terminal device 120 are equipped with multiple antenna ports (or antenna elements) and can transmit specified RS sequences with the antenna ports (antenna elements). A set of RS resources associated with a number of RS ports are also specified. A RS port may be referred to as a specific mapping of part or all of a RS sequence to one or more resource elements of a resource region allocated for RS transmission in time, frequency, and/or code domains.

FIG. 2 shows a process 200 for SRS communication according to some implementations of the present disclosure. For the purpose of discussion, the process 200 will be described with reference to FIG. 1. The process 200 may involve the network device 110 and the terminal device 120 as shown in FIG. 1. It is to be understood that the process 200 may include additional acts not shown and/or may omit some acts as shown, and the scope of the present disclosure is not limited in this regard.

As shown in FIG. 2, the network device 110 may transmit 210 SRS hopping parameters and a partial sounding parameter to the terminal device 120. The SRS hopping parameters relate to a SRS bandwidth configuration. For example, the SRS hopping parameters may include B_{SRS}, C_{SRS} and bₕₒₚ as defined in Clause 6.4.1.4 of the 3GPP specification TS 38.211. For example, B_{SRS} can be any one of {0, 1, 2, 3}. For example, bₕₒₚ can be any one of {0, 1, 2, 3}. For example, C_{SRS} is a non-negative integer, and 0 ≤ C_{SRS} ≤ 63. For example, the SRS bandwidth configuration may be shown in Table 1 in the following. In some embodiments, the partial sounding parameter may indicate whether partial sounding across frequency is enabled or not implicitly or explicitly. In some embodiments, the SRS hopping parameters may be transmitted from the network device 110 to the terminal device 120 via Radio Resource Control (RRC) signaling. In some embodiments, the partial sounding parameter may be transmitted from the network device 110 to the terminal device 120 via any of RRC signaling, Media Access Control (MAC) Control Element (CE) and Downlink Control Information (DCI). In response to receiving the SRS hopping parameters and the partial sounding parameter from the network device 110, the terminal device 120 may transmit 220 SRS sequences to the network device 110 based on the SRS hopping parameters and the partial sounding parameter. The network device 110 may receive the SRS sequences from the terminal device 120 based on the SRS hopping parameters and the partial sounding parameter.

TABLE 1

SRS bandwidth configuration

| C_{SRS} | B_{SRS} = 0 | | B_{SRS} = 1 | | B_{SRS} = 2 | | B_{SRS} = 3 | |
|---|---|---|---|---|---|---|---|---|
| | M_{SRS,0} | N₀ | m_{SRS,1} | N₁ | m_{SRS,2} | N₂ | m_{SRS,3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

In some embodiments, the SRS hopping parameters may indicate a frequency bandwidth (also referred to as “sounding bandwidth” in the following) for SRS transmission. If the partial sounding across frequency is enabled or configured, the SRS sequences may be transmitted over a part of the sounding bandwidth. In some embodiments, the number of resource blocks (RBs) configured for the sounding bandwidth is N and the number of non-overlapped RBs used for SRS transmission is T, where N is an integer and 4 ≤ N ≤ 272 and where T is an integer and 1 ≤ T ≤ 136. In other words, the non-overlapped RBs used for SRS transmission are only a subset of the RBs configured for the sounding bandwidth. In some embodiments, the RBs used for SRS transmission within one sub-band are continuous. In some embodiments, the minimum number of RBs used for one SRS transmission is M, for example, M = 4.

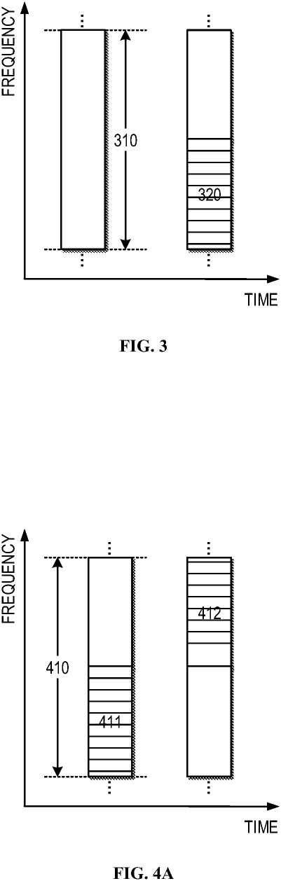

FIG. 3 illustrates an example of such embodiments. FIG. 3 shows a sounding bandwidth 310 is configured for SRS transmission. In some embodiments, if partial sounding across frequency is enabled or configured, the non-overlapped RBs 320 used for SRS transmission may occupy only a part of the sounding bandwidth 310.

In some embodiments, the SRS hopping parameters may indicate a band or sub-band comprising a number of resource blocks for SRS transmission. If the partial sounding across frequency is enabled or configured, the SRS sequences may be transmitted over a part of the resource blocks within the band or sub-band. In some embodiments, the number of resource blocks (RBs) configured for the band or sub-band is N and the number of RBs used for SRS transmission within the band or sub-band is T, where N is an integer and 4 ≤ N ≤ 272 and where T is an integer and 1 ≤ T ≤ 136. In some embodiments, the RBs used for SRS transmission within one sub-band are continuous. In some embodiments, the minimum number of RBs used for one SRS transmission is M, for example, M = 4. In some embodiments, T = N * (1/X), where X is an integer and 2 ≤ X ≤ 16. Alternatively, T = max (N * (1/X), M). In some embodiments, T or X may be predefined based on the value of N. Alternatively, T or X may be configured to the terminal device 120 via any of RRC signaling, MAC CE and DCI.

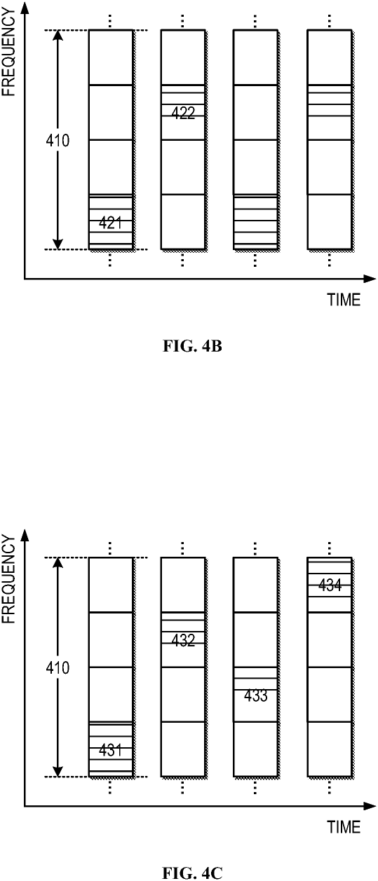

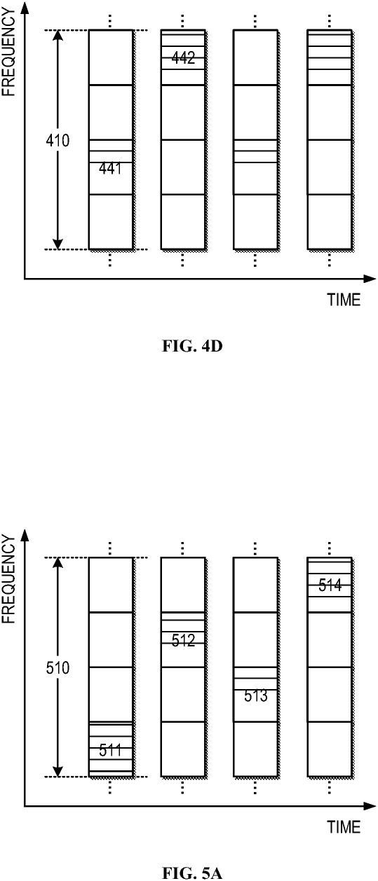

FIGS. 4A and 4B illustrate an example of such embodiments. FIG. 4A shows a sounding bandwidth 410 is configured for SRS transmission, in which two sub-bands 411 and 412 cover the sounding bandwidth 410. In some embodiments, if partial sounding across frequency is enabled or configured, the non-overlapped RBs 421 used for SRS transmission within the sub-band 411 may occupy only a part of the sub-band 411 and the non-overlapped RBs 422 used for SRS transmission within the sub-band 412 may occupy only a part of the sub-band 412. In some embodiments, the other RBs in each sub-band can be configured to other terminal devices (if any) to improve SRS capacity.

In some embodiments, the terminal device 120 may be configured with the SRS hopping parameters B_{SRS}, C_{SRS} and b_{hop.} In some embodiments, the terminal device 120 may also be configured with the partial sounding paramter Bₚₐᵣₜᵢₐₗ. For example, Bₚₐᵣₜᵢₐₗ can be any one of {0, 1, 2, 3, 4}. For example, if Bₚₐᵣₜᵢₐₗ > B_{SRS}, it means that the partial sounding across frequency is enabled or configured; otherwise, the partial sounding across frequency is disabled. In some embodiments, the terminal device 120 may also be configured with an offset Oₚₐᵣₜᵢₐₗ and the partial sounding paramter Bₚₐᵣₜᵢₐₗ = B_{SRS} + Oₚₐᵣₜᵢₐₗ, where Oₚₐᵣₜᵢₐₗ equals to 0 or 1 or 2 or 3. For example, if Oₚₐᵣₜᵢₐₗ = 0, it means that the partial sounding across frequency is disabled; and if Oₚₐᵣₜᵢₐₗ= 1 or 2 or 3, it means that the partial sounding across frequency is enabled.

In some embodiments, the length of SRS sequence, the frequency-domain stating position and/or the frequency position indices for SRS trasnmission can be determined based on the SRS hopping parameters and the partial sounding paramter Bₚₐᵣₜᵢₐₗ, so as to reduce the numer of transmitted RBs within one sub-band.

In some embodiments, the length of SRS sequency may be given by

$${M}_{\text{sc,} b}^{\text{SRS}} = {m}_{\text{SRS,} b} {N}_{\text{sc}}^{\text{RB}} / {K}_{\text{TC}}$$

where m_{SRS,b} is given by a selected row of Table 1 or Table 6.4.1.4.3-1 in Clause 6.4.1.4.3 of the 3GPP specification TS 38.211 with b = Bₚₐᵣₜᵢₐₗ. The row of the table is selected according to the index C_{SRS} ∈ {0,1,...,63} given by the field c-SRS contained in the higher-layer parameter freqHopping.

In some embodiments, the frequency-domain starting position

$${k}_{0}^{\left({p}_{i}\right)}$$

is defined by

$${k}_{0}^{\left({p}_{i}\right)} = {\overline{k}}_{0}^{\left({p}_{i}\right)} + {\sum }_{b = 0}^{{B}_{p a r t i a l}} {K}_{\text{TC}} {M}_{\text{sc,} b}^{\text{SRS}} {n}_{b}$$

where

$${\overline{k}}_{0}^{\left({p}_{i}\right)}$$

is defined in the same way as Clause 6.4.1.4.3 of the 3GPP specification TS 38.211.

In some embodiments, if bₕₒₚ < Bₚₐᵣₜᵢₐₗ and/or if B_{SRS} < Bₚₐᵣₜᵢₐₗ and/or if B_{SRS} ≤ Bₚₐᵣₜᵢₐₗ and/or if bₕₒₚ < B_{SRS}, partial frequency hopping is enabled and the frequency position indices n_{b} are defined by

$${n}_{b} = \left\{\begin{matrix}\left⌊4 {n}_{\text{RRC}} / {m}_{\text{SRS,} b}\right⌋ mod {N}_{\text{b}} & b \leq {b}_{\text{hop}} \\ \left({F}_{b} \left({n}_{\text{SRS}}\right) + \left⌊4 {n}_{\text{RRC}} / {m}_{\text{SRS,} b}\right⌋\right) mod {N}_{\text{b}} & \text{otherwise}\end{matrix}\right)$$

where N_{b} is given by Table 6.4.1.4.3-1 in Clause 6.4.1.4.3 of the 3GPP specification TS 38.211, and F_{b}(n_{SRS}) is defined in the same way as Clause 6.4.1.4.3 of the 3GPP specification TS 38.211. For example, the resource pattern for partial sounding across frequency in accordance with such embodiments is shown in FIG. 4C. As shown in FIG. 4C, if partial sounding across frequency is enabled and if the partial sounding parameter Bₚₐᵣₜᵢₐₗ ≤ 3, the resource pattern for partial sounding across frequency may be shown in FIG. 4C, where sub-bands 431-434 are used for SRS transmission. Since the partial sounding parameter can be configured dynamically (for example, via MAC CE or DCI) to the terminal device 120, the partial sounding across frequency can be enabled dynamically.

In some embodiments, the length of SRS sequence, the frequency-domain stating position and/or the frequency position indices for SRS trasnmission can be determined based on the SRS hopping parameters and the partial sounding paramter Bₚₐᵣₜᵢₐₗ, so as to reduce the numer of transmitted RBs within one sub-band.

In some embodiments, the length of SRS sequency may be given by

$${M}_{\text{sc,} b}^{\text{SRS}} = {m}_{\text{SRS,} b} {N}_{\text{sc}}^{\text{RB}} / {K}_{\text{TC}}$$

where m_{SRS},_{b} is given by a selected row of Table 1 or Table 6.4.1.4.3-1 in Clause 6.4.1.4.3 of the 3GPP specification TS 38.211 with b = Bₚₐᵣₜᵢₐₗ. The row of the table is selected according to the index C_{SRS} ∈ {0,1,...,63} given by the field c-SRS contained in the higher-layer parameter freqHopping.

In some embodiments, the frequency-domain starting position

$${k}_{0}^{\left({p}_{i}\right)}$$

is defined by

$${k}_{0}^{\left({p}_{i}\right)} = {\overline{k}}_{0}^{\left({p}_{i}\right)} + {\sum }_{b = 0}^{{B}_{p a r t i a l}} {K}_{\text{TC}} {M}_{\text{sc,} b}^{\text{SRS}} {n}_{b}$$

where

$${\overline{k}}_{0}^{\left({p}_{i}\right)}$$

is defined in the same way as Clause 6.4.1.4.3 of the 3GPP specification TS 38.211.

In some embodiments, if bₕₒₚ < Bₚₐᵣₜᵢₐₗ and/or if B_{SRS} < Bₚₐᵣₜᵢₐₗ and/or if B_{SRS} ≤ Bₚₐᵣₜᵢₐₗ and/or if bₕₒₚ < B_{SRS}, partial frequency hopping is enabled and the frequency position indices n_{b} are defined by

$${n}_{b} = \left\{\begin{matrix}\left⌊4 {n}_{\text{RRC}} / {m}_{\text{SRS,} b}\right⌋ mod {N}_{\text{b}} & b \leq {b}_{\text{hop}} , o r b = {B}_{p a r t i a l} \\ \left({F}_{b} \left({n}_{\text{SRS}}\right) + \left⌊4 {n}_{\text{RRC}} / {m}_{\text{SRS,} b}\right⌋\right) mod {N}_{\text{b}} & \text{otherwise}\end{matrix}\right)$$

where N_{b} is given by Table 6.4.1.4.3-1 in Clause 6.4.1.4.3 of the 3GPP specification TS 38.211, and F_{b}(n_{SRS}) is defined in the same way as Clause 6.4.1.4.3 of the 3GPP specification TS 38.211. For example, the resource pattern for partial sounding across frequency in accordance with such embodiments is shown in FIG. 4B.

In some embodiments, the length of SRS sequence, the frequency-domain stating position and/or the frequency position indices for SRS trasnmission can be determined based on the SRS hopping parameters and the partial sounding paramter Bₚₐᵣₜᵢₐₗ, so as to reduce the numer of transmitted RBs within one sub-band.

In some embodiments, the length of SRS sequency may be given by

$${M}_{\text{sc,} b}^{\text{SRS}} = {m}_{\text{SRS,} b} {N}_{\text{sc}}^{\text{RB}} / {K}_{\text{TC}}$$

where m_{SRS,b} is given by a selected row of Table 1 or Table 6.4.1.4.3-1 in Clause 6.4.1.4.3 of the 3GPP specification TS 38.211 with b = Bₚₐᵣₜᵢₐₗ. The row of the table is selected according to the index C_{SRS} ∈ {0,1,...,63} given by the field c-SRS contained in the higher-layer parameter freqHopping.

In some embodiments, the frequency-domain starting position

$${k}_{0}^{\left({p}_{i}\right)}$$

is defined by

$${k}_{0}^{\left({p}_{i}\right)} = {\overline{k}}_{0}^{\left({p}_{i}\right)} + {\sum }_{b = 0}^{{B}_{p a r t i a l}} {K}_{\text{TC}} {M}_{\text{sc,} b}^{\text{SRS}} {n}_{b}$$

where

$${\overline{k}}_{0}^{\left({p}_{i}\right)}$$

is defined in the same way as Clause 6.4.1.4.3 of the 3GPP specification TS 38.211.

In some embodiments, if bₕₒₚ < Bₚₐᵣₜᵢₐₗ and/or if B_{SRS} < Bₚₐᵣₜᵢₐₗ and/or if B_{SRS} ≤ Bₚₐᵣₜᵢₐₗ and/or if bₕₒₚ < B_{SRS}, partial frequency hopping is enabled and the frequency position indices n_{b} are defined by

$$\begin{matrix}{n}_{b} = \\ \left\{\begin{matrix}\left⌊4 {n}_{\text{RRC}} / {m}_{\text{SRS,} b}\right⌋ mod {N}_{\text{b}} & b \leq {b}_{\text{hop}} \\ i & b = B \\ \left({F}_{b} \left({n}_{\text{SRS}}\right) + \left⌊4 {n}_{\text{RRC}} / {m}_{\text{SRS,} b}\right⌋\right) mod {N}_{\text{b}} & o t h e r w i s e\end{matrix}\right)\end{matrix}$$

where 0 ≤ i ≤NBₚₐᵣₜᵢₐₗ-1. For example, i may be configured or calculated based on a sequence and/or group hopping identifier (ID). N_{b} is given by Table 6.4.1.4.3-1 in Clause 6.4.1.4.3 of the 3GPP specification TS 38.211, and F_{b}(n_{SRS}) is defined in the same way as Clause 6.4.1.4.3 of the 3GPP specification TS 38.211. For example, if i = 0, the resource pattern for partial sounding across frequency is shown as FIG. 4B; and if i = 1, the resource pattern for partial sounding across frequency is shown as FIG. 4D.

As shown in FIG. 4D, if partial sounding across frequency is enable and if i = 1, the non-overlapped RBs 441 used for SRS transmission within the sub-band 411 may occupy only a part of the sub-band 411 and the non-overlapped RBs 442 used for SRS transmission within the sub-band 412 may occupy only a part of the sub-band 412. In some embodiments, the other RBs in each sub-band can be configured to other terminal devices (if any) to improve SRS capacity.

In some embodiments, the terminal device 120 may be configured with the SRS hopping parameters B_{SRS}, C_{SRS} and b_{hop.} In some embodiments, the terminal device 120 may also be configured with the partial sounding paramter Bₚₐᵣₜᵢₐₗ. If Bₚₐᵣₜᵢₐₗ > B_{SRS} (where Bₚₐᵣₜᵢₐₗ is an integer and 0 ≤ Bₚₐᵣₜᵢₐₗ ≤ 3), it means that the partial sounding across frequency is enabled. If Bₚₐᵣₜᵢₐₗ ≤ B_{SRS}, it means that the partial sounding across frequency is disabled. In some embodiments, the terminal device 120 may also be configured with an offset Oₚₐᵣₜᵢₐₗ and the partial sounding paramter Bₚₐᵣₜᵢₐₗ = min (B_{SRS} + Oₚₐᵣₜᵢₐₗ, 3), where Oₚₐᵣₜᵢₐₗ equals to 0 or 1 or 2 or 3. For example, if Oₚₐᵣₜᵢₐₗ = 0, it means that the partial sounding across frequency is disabled; and if Oₚₐᵣₜᵢₐₗ= 1 or 2 or 3, it means that the partial sounding across frequency is enabled. Alternatively, if Bₚₐᵣₜᵢₐₗ > 3, then NBₚₐᵣₜᵢₐₗ=4. The minimum bandwidth for SRS transmission is maintained as 4 RBs.

In some embodiments, the terminal device 120 may be configured with the SRS hopping parameters B_{SRS}, C_{SRS} and b_{hop.} In some embodiments, the terminal device 120 may also be configured with the partial sounding paramter Bₚₐᵣₜᵢₐₗ. If Bₚₐᵣₜᵢₐₗ > B_{SRS} (where Bₚₐᵣₜᵢₐₗ is an integer and 0 ≤ Bₚₐᵣₜᵢₐₗ ≤ 4), it means that the partial sounding across frequency is enabled. If Bₚₐᵣₜᵢₐₗ ≤ B_{SRS}, it means that the partial sounding across frequency is disabled. In some embodiments, the terminal device 120 may also be configured with an offset Oₚₐᵣₜᵢₐₗ and the partial sounding paramter Bₚₐᵣₜᵢₐₗ = B_{SRS} + Oₚₐᵣₜᵢₐₗ, where Oₚₐᵣₜᵢₐₗ equals to 0 or 1 or 2 or 3. For example, if Oₚₐᵣₜᵢₐₗ= 0, it means that the partial sounding across frequency is disabled; and if Oₚₐᵣₜᵢₐₗ = 1 or 2 or 3, it means that the partial sounding across frequency is enabled. Alternatively, if B_{SRS} = 3 and if the partial sounding across frequency is enabled, for example, Bₚₐᵣₜᵢₐₗ= 4. For example, in this case, NBₚₐᵣₜᵢₐₗ = 2 or 3 or 4. The minimum bandwidth for SRS transmission may be

$$4 / {N}_{{B}_{p a r t i a l}}$$

RBs. For another example, in this case, m_{SRS}, Bₚₐᵣₜᵢₐₗ = 2 or 3 or 4. In this event, a new length and/or a new comb value for SRS sequence may be needed, for examle, the new length of SRS sequence is 6 or 8, or the new comb value for SRS sequence is 1.

In some embodiments, the SRS hopping parameters may indicate a sounding bandwidth for SRS transmission and a first number of hops to cover the sounding bandwidth. If the partial sounding across frequency is enabled, the SRS sequences may be transmitted through a second number of hops, where the second number is less than the first number. For example, according to the current specification, the number of hops to cover the configured sounding bandwidth is H, where

$$\text{H=} {\prod }_{{b}^{′} = {b}_{\text{hop}}}^{b} {N}_{{b}^{′}}$$

, where Nbₕₒₚ = 1 regardless of the value of N_{b}. In some embodiments, if the partial sounding across frequency is enabled, the number of hops used for SRS transmission is G, where G is an integer and 1 ≤ G < H and the G hops are non-overlapped in frequency domain. In some embodiments, G = ceil (H/2) or floor (H/2). In some embodiments, the number of RBs used for SRS transmission in a sub-band is the same as the number of RBs configured for the sub-band. In some embodiments, the reduction of the hops/sub-bands for SRS transmission can be applied if H > 1 or if SRS frequency hopping is enabled. In the following, the terms “band(s)”, “bandwidth”, “hop(s)” and “sub-band(s)” can be used interchangeably.

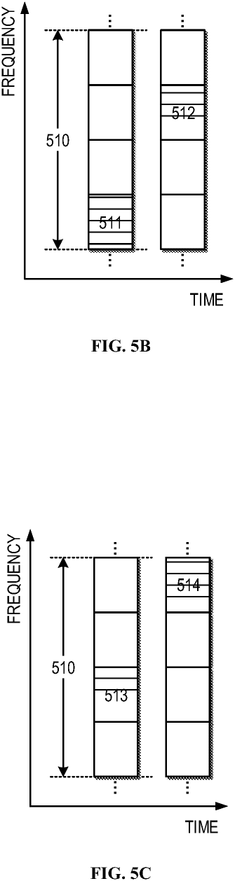

FIGS. 5A∼5C illustrate an example of such embodiments. FIG. 5A shows a sounding bandwidth 510 is configured for SRS transmission, in which 4 sub-bands/hops 511~514 cover the sounding bandwidth 510, that is, H = 4. In some embodiments, if the partial sounding across frequency is enabled, the number of hops used for SRS transmission may be 2. That is, G = 2. For example, FIG. 5B and FIG. 5C illustrate two example resource patterns for the partial sounding across frequency. In FIG. 5B, the non-overlapped and non-contiguous sub-bands/hops 511 and 512 are used for SRS transmission. In FIG. 5C, the non-overlapped and non-contiguous sub-bands/hops 513 and 514 are used for SRS transmission.

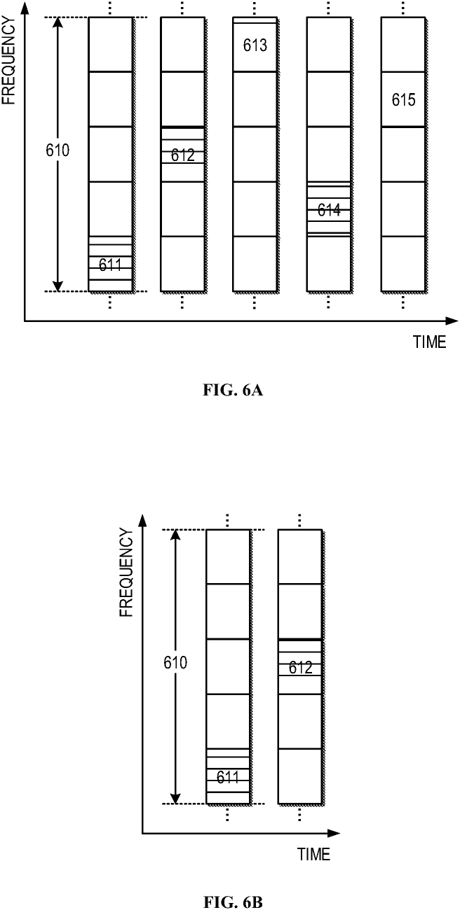

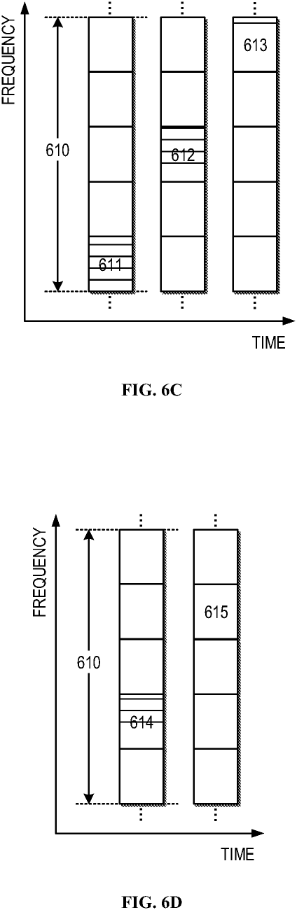

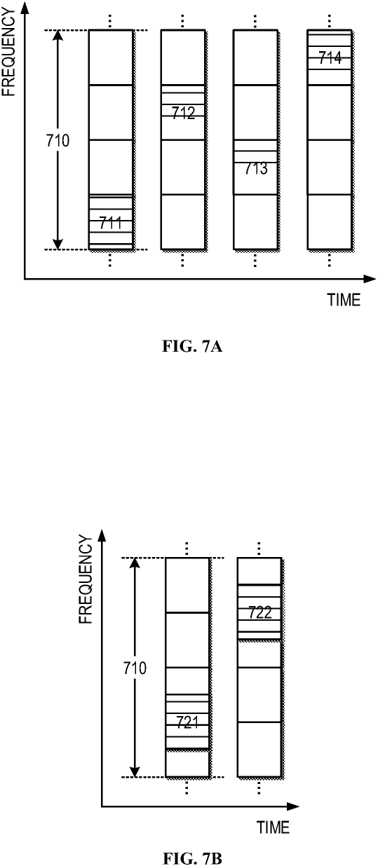

FIGS. 6A∼6D illustrate another example of such embodiments. FIG. 6A shows a sounding bandwidth 610 is configured for SRS transmission, in which 5 sub-bands/hops 611~615 cover the sounding bandwidth 610. That is, H = 5. In some embodiments, if the partial sounding across frequency is enabled, the number of hops used for SRS transmission may be 2 or 3. That is, G = 2 or 3. For example, FIGS. 6B~6D illustrate three example resource patterns for the partial sounding across frequency. In FIG. 6B, the non-overlapped and non-contiguous sub-bands/hops 611 and 612 are used for SRS transmission. In FIG. 6C, the non-overlapped and non-contiguous sub-bands/hops 611~613 are used for SRS transmission. In FIG. 6D, the non-overlapped and non-contiguous sub-bands/hops 614 and 615 are used for SRS transmission.

In some embodiments, the terminal device 120 may be configured with the SRS hopping parameters B_{SRS}, C_{SRS} and bₕₒₚ. In some embodiments, the terminal device 120 may also be configured with a partial sounding paramter which indicates whether the partial sounding across frequency is enabled or not. In some embodiments, the length of SRS sequence, the frequency-domain stating position and/or the frequency position indices for SRS trasnmission can be determined based on the SRS hopping parameters and the partial sounding paramter, so as to reduce the numer of hops/sub-bands.

In some embodiments, the length of SRS sequency may be given by

$${M}_{\text{sc,} b}^{\text{SRS}} = {m}_{\text{SRS,} b} {N}_{\text{sc}}^{\text{RB}} / {K}_{\text{TC}}$$

where m_{SRS},_{b} is given by a selected row of Table 1 or Table 6.4.1.4.3-1 in Clause 6.4.1.4.3 of the 3GPP specification TS 38.211 with b = B_{SRS}. The row of the table is selected according to the index C_{SRS} ∈ {0,1,...,63} given by the field c-SRS contained in the higher-layer parameter freqHopping.

In some embodiments, the frequency-domain starting position

$${k}_{0}^{\left({p}_{i}\right)}$$

is defined by

$${k}_{0}^{\left({p}_{i}\right)} = {\overline{k}}_{0}^{\left({p}_{i}\right)} + {\sum }_{b = 0}^{{B}_{\text{SRS}}} {K}_{\text{TC}} {M}_{\text{sc,} b}^{\text{SRS}} {n}_{b}$$

where

$${\overline{k}}_{0}^{\left({p}_{i}\right)}$$

is defined in the same way as Clause 6.4.1.4.3 of the 3GPP specification TS 38.211.

In some embodiments, if bₕₒₚ < B_{SRS}, and if partial frequency hopping is enabled, the frequency position indices n_{b} are defined by

$${n}_{b} = \left\{\begin{matrix}\left⌊4 {n}_{\text{RRC}} / {m}_{\text{SRS,} b}\right⌋ mod {N}_{\text{b}} & b \leq {b}_{\text{hop}} o r b = {B}_{S R S} \\ \left({F}_{b} \left({n}_{\text{SRS}}\right) + \left⌊4 {n}_{\text{RRC}} / {m}_{\text{SRS,} b}\right⌋\right) mod {N}_{\text{b}} & \text{otherwise}\end{matrix}\right)$$

where N_{b} is given by Table 6.4.1.4.3-1 in Clause 6.4.1.4.3 of the 3GPP specification TS 38.211, and F_{b}(n_{SRS}) is defined in the same way as Clause 6.4.1.4.3 of the 3GPP specification TS 38.211.

According to the current specification, the number of hops to cover the configured sounding bandwidth is H, where

$$\text{H=} {\prod }_{{b}^{′} = {b}_{\text{hop}}}^{b} {N}_{{b}^{′}} ,$$

where N_{bₕₒₚ} = 1 regardless of the value of N_{b}. In some embodiments, if the partial sounding across frequency is enabled, the number of hops used for SRS transmission is G, where G is an integer and 1 ≤ G < H and the G hops are non-overlapped in frequency domain. In some embodiments, G = ceil (H/2) or floor (H/2). In some embodiments, the number of RBs used for SRS transmission in a sub-band is the same as the number of RBs configured for the sub-band. In some embodiments, the reduction of the hops/subbands for SRS transmission can be applied if H > 1 or if SRS frequency hopping is enabled.

In some embodiments, RBs used for SRS transmission in one of the G hops may be overlapped with two contiguous sub-bands and the G hops may not exceed the range of the sounding bandwidth.

FIGS. 7A and 7B illustrate examples of such embodiments. FIG. 7A shows a sounding bandwidth 710 is configured for SRS transmission, in which 4 sub-bands 711-714 cover the sounding bandwidth 710. That is, H = 4. In some embodiments, if the partial sounding across frequency is enabled, the number of hops used for SRS transmission may be 2. That is, G = 2. For example, FIG. 7B illustrates an example resource pattern for the partial sounding across frequency. In FIG. 7B, two hops 721 and 722 are used for SRS transmission, where RBs used for SRS transmission in the hop 721 is overlapped with the contiguous sub-bands 711 and 713 and where RBs used for SRS transmission in the hop 722 is overlapped with the contiguous sub-bands 712 and 714.

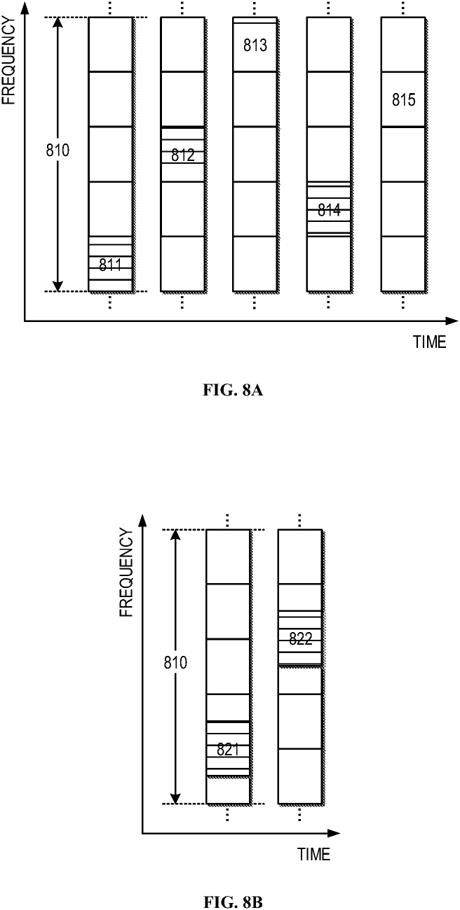

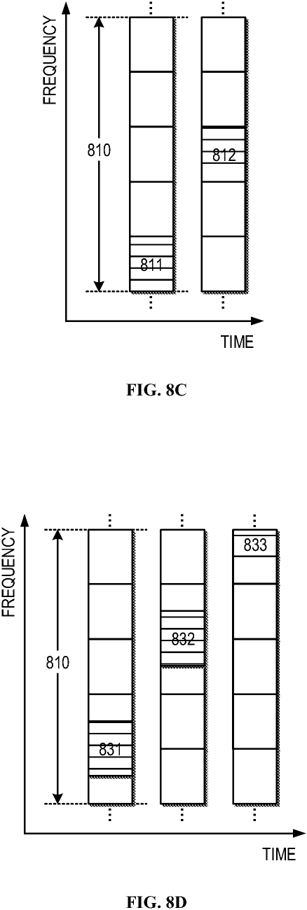

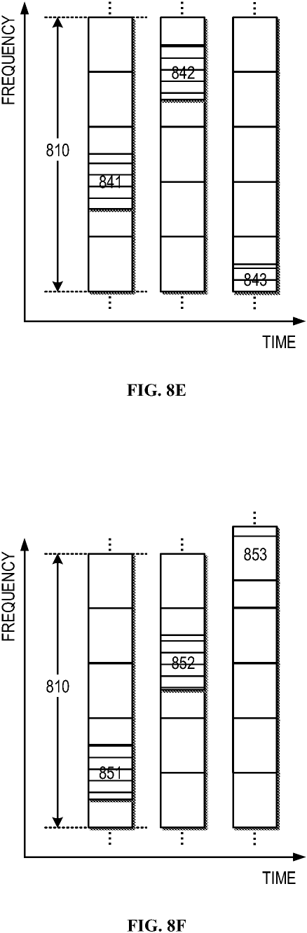

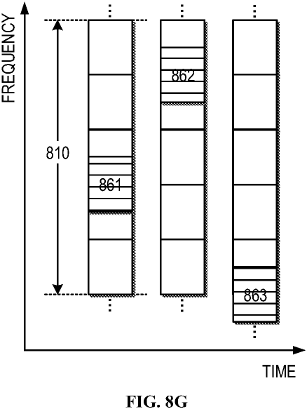

FIGS. 8A∼8C illustrate other examples of such embodiments. FIG. 8A shows a sounding bandwidth 810 is configured for SRS transmission, in which 5 sub-bands 811-815 cover the sounding bandwidth 810. That is, H = 5. In some embodiments, if the partial sounding across frequency is enabled, the number of hops used for SRS transmission may be 2. That is, G = 2. For example, FIGS. 8B and 8C illustrate two example resource pattern for the partial sounding across frequency. In FIG. 8B, two hops 821 and 822 are used for SRS transmission, where RBs used for SRS transmission in the hop 821 is overlapped with the contiguous sub-bands 811 and 814 and where RBs used for SRS transmission in the hop 822 is overlapped with the contiguous sub-bands 812 and 815. In FIG. 8C, the non-overlapped and non-contiguous sub-bands/hops 811 and 812 are used for SRS transmission.

In some embodiments, RBs used for SRS transmission in one of the G hops may be overlapped with two contiguous sub-bands and the G hops may not exceed the range of the sounding bandwidth. In some embodiments, if a part of one of the G hops goes beyond the range of the sound bandwidth, the part may be dropped. In some embodiments, the number of RBs for the lowest and/or highest sub-band in frequency domain within the sounding bandwidth may be less than the number of RBs for the other sub-bands. For example, if the lowest and/or the highest sub-band in frequency domain exceed the range of the sounding bandwidth, only the RBs within the sounding bandwidth will be used for SRS transmission in the sub-band.

FIGS. 8D and 8E illustrate examples of such embodiments. As shown in FIG. 8A, a sounding bandwidth 810 is configured for SRS transmission, in which 5 sub-bands 811-815 cover the sounding bandwidth 810. That is, H = 5. In some embodiments, if the partial sounding across frequency is enabled, the number of hops used for SRS transmission may be 3. That is, G = 3. For example, FIGS. 8D and 8E illustrate two example resource pattern for the partial sounding across frequency. In FIG. 8D, three hops 831, 832 and 833 are used for SRS transmission. RBs used for SRS transmission in the hop 831 is overlapped with the contiguous sub-bands 811 and 814. RBs used for SRS transmission in the hop 832 is overlapped with the contiguous sub-bands 812 and 815. The hop 833 occupies only a part of the sub-band 813. For example, the part of the hop 833 out of the range of the sounding bandwidth is dropped. In FIG. 8E, three hops 841, 842 and 843 are used for SRS transmission. RBs used for SRS transmission in the hop 841 is overlapped with the contiguous sub-bands 814 and 812. RBs used for SRS transmission in the hop 842 is overlapped with the contiguous sub-bands 815 and 813. The hop 843 occupies only a part of the sub-band 811. For example, the part of the hop 843 out of the range of the sounding bandwidth is dropped.

In some embodiments, RBs used for SRS transmission in one of the G hops may be overlapped with two contiguous sub-bands and at least one of the G hops may exceed the range of the sounding bandwidth.

FIGS. 8F and 8G illustrate examples of such embodiments. As shown in FIG. 8A, a sounding bandwidth 810 is configured for SRS transmission, in which 5 sub-bands 811-815 cover the sounding bandwidth 810. That is, H = 5. In some embodiments, if the partial sounding across frequency is enabled, the number of hops used for SRS transmission may be 3. That is, G = 3. For example, FIGS. 8F and 8G illustrate two example resource pattern for the partial sounding across frequency. In FIG. 8F, three hops 851, 852 and 853 are used for SRS transmission. RBs used for SRS transmission in the hop 851 is overlapped with the contiguous sub-bands 811 and 814. RBs used for SRS transmission in the hop 852 is overlapped with the contiguous sub-bands 812 and 815. The hop 853 goes beyond the rand of the sounding bandwidth 810, so as to ensure integrity of the SRS sequence. In FIG. 8G, three hops 861, 862 and 863 are used for SRS transmission. RBs used for SRS transmission in the hop 861 is overlapped with the contiguous sub-bands 814 and 812. RBs used for SRS transmission in the hop 862 is overlapped with the contiguous sub-bands 815 and 813. The hop 863 goes beyond the rand of the sounding bandwidth 810, so as to ensure integrity of the SRS sequence.

In some embodiments, RBs used for SRS transmission in one of the G hops may be overlapped with two contiguous sub-bands. In some embodiments, an offset may be configured or predefined based on the number of RBs in a SRS sub-band. For example, the offset may be configured to the terminal device 120 via any of RRC signaling, MAC CE and DCI. For another example, the offset may be predefined as half of the sub-band, such as, m_{SRS,}B_{SRS}/2.

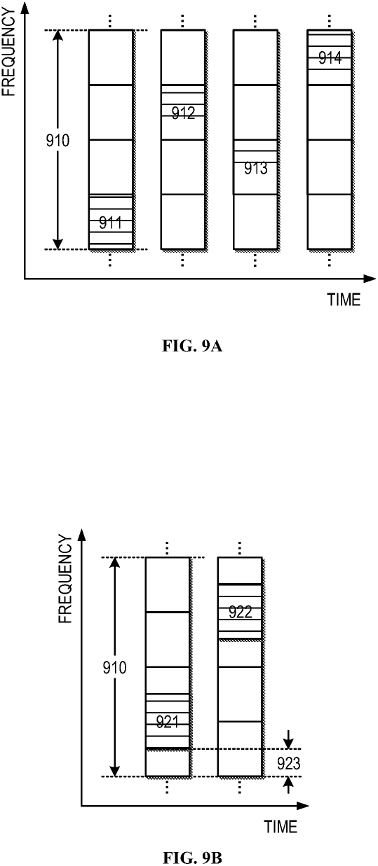

FIGS. 9A and 9B illustrate examples of such embodiments. As shown in FIG. 9A, a sounding bandwidth 910 is configured for SRS transmission, in which 4 sub-bands 911-914 cover the sounding bandwidth 910. That is, H = 4. In some embodiments, if the partial sounding across frequency is enabled, the number of hops used for SRS transmission may be 2. That is, G = 2. For example, FIG. 9B illustrates an example resource pattern for the partial sounding across frequency. In FIG. 9B, two hops 921 and 922 are used for SRS transmission, where RBs used for SRS transmission in the hop 921 is overlapped with the contiguous sub-bands 911 and 913, and RBs used for SRS transmission in the hop 922 is overlapped with the contiguous sub-bands 912 and 914. For example, the frequency positions of the hops 921 and/or 922 can be determined based on an offset 923.

In some embodiments, the terminal device 120 may be configured with the SRS hopping parameters B_{SRS}, C_{SRS} and b_{hop.} In some embodiments, the terminal device 120 may also be configured with a partial sounding paramter which indicates whether the partial sounding across frequency is enabled or not. In some embodiments, the length of SRS sequence, the frequency-domain stating position and/or the frequency position indices for SRS trasnmission can be determined based on the SRS hopping parameters and the partial sounding paramter, so as to reduce the numer of hops/sub-bands.

In some embodiments, the length of SRS sequency may be given by

$${M}_{\text{sc,} b}^{\text{SRS}} = {m}_{\text{SRS,} b} {N}_{\text{sc}}^{\text{RB}} / {K}_{\text{TC}}$$

where m_{SRS,b} is given by a selected row of Table 1 or Table 6.4.1.4.3-1 in Clause 6.4.1.4.3 of the 3GPP specification TS 38.211 with b = B_{SRS}. The row of the table is selected according to the index C_{SRS} ∈ {0,1,...,63} given by the field c-SRS contained in the higher-layer parameter freqHopping.

In some embodiments, the frequency-domain starting position

$${k}_{0}^{\left({p}_{i}\right)}$$

is defined by

$${k}_{0}^{\left({p}_{i}\right)} = {\overline{k}}_{0}^{\left({p}_{i}\right)} + {\sum }_{b = 0}^{{B}_{\text{SRS}}} {K}_{\text{TC}} {M}_{\text{sc,} b}^{\text{SRS}} {n}_{b}$$

where

$${\overline{k}}_{0}^{\left({p}_{i}\right)}$$

is defined in the same way as Clause 6.4.1.4.3 of the 3GPP specification TS 38.211.

In some embodiments, if bₕₒₚ < B_{SRS}, and if partial frequency hopping is enabled, the frequency position indices n_{b} are defined by

$$\begin{matrix}{n}_{b} = \\ \left\{\begin{matrix}\left⌊4 {n}_{\text{RRC}} / {m}_{\text{SRS,} b}\right⌋ mod {N}_{\text{b}} & b \leq {b}_{\text{hop}} \\ \left({F}_{b} \left({n}_{\text{SRS}}\right) + \left⌊4 {n}_{\text{RRC}} / {m}_{\text{SRS,} b}\right⌋\right) mod {N}_{\text{b}} + 1 / 2 & b = {B}_{S R S} \\ \left({F}_{b} \left({n}_{\text{SRS}}\right) + \left⌊4 {n}_{\text{RRC}} / {m}_{\text{SRS,} b}\right⌋\right) mod {N}_{\text{b}} & o t h e r w i s e\end{matrix}\right)\end{matrix}$$

where N_{b} is given by Table 6.4.1.4.3-1 in Clause 6.4.1.4.3 of the 3GPP specification TS 38.211, and F_{b}(n_{SRS}) is defined in the same way as Clause 6.4.1.4.3 of the 3GPP specification TS 38.211.

In some embodiments, if the partial sounding across frequency is enabled, the comb value for generating SRS sequences can be increased to improve SRS capacity or coverage. According to the current specification, the comb value K_{TC} for SRS (except SRS for positioning) is 2 or 4. If the partial sounding across frequency is enabled, a new comb value K_{TC_}_{P} can be used, where K_{TC_}_{P} > K_{TC}. For example, K_{TC_}_{P} = N * K_{TC}, where N is any of 2, 3, 4 or 6. In some embodiments, the minimum length of SRS sequence may be 12. For example, if m_{SRS,b}= 4 and K_{TC} = 4, then K_{TC_}_{P} = 4. That is, in this case, the partial sounding across frequency is disabled. In some embodiments, the minimum length of SRS sequence may be 6. For example, if m_{SRS},_{b=} 4 and K_{TC} = 4, then K_{TC_}_{P} = 8. In some embodiments, the minimum length of SRS sequence may be 8. For example, if m_{SRS,b}= 4 and K_{TC} = 4, then K_{TC_}_{P} = 6.

In some embodiments, the SRS hopping parameters may indicate a sounding bandwidth for SRS transmission and a number of hops/sub-bands to cover the sounding bandwidth. In some embodiments, the partial sounding parameter may be a bitmap for selecting which one of the sub-bands is configured for SRS transmission. For example, if one of the sub-bands is configured for SRS transmission, a corresponding bit in the bitmap can be set to ‘1’; and if the sub-bands is not configured for SRS transmission, a corresponding bit in the bitmap can be set to ‘0’. In some embodiments, the bitmap can be configured to the terminal device 120 via any of RRC signaling, MAC CE or DCI. In some embodiments, the size of bitmap is ceil

$$\left(log 2 \left({\prod }_{{b}^{′} = {b}_{\text{hop}}}^{b} {N}_{{b}^{′}}\right)\right)$$

bits, where NBₕₒₚ = 1 regardless of the value of N_{b}.

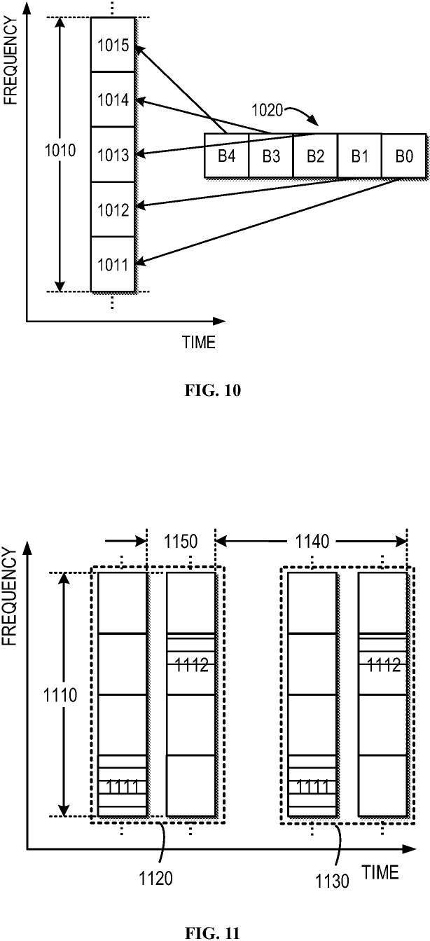

FIG. 10 illustrates an example of such embodiments. As shown in FIG. 10, a sounding bandwidth 1010 is configured for SRS transmission, which is divided into 5 sub-bands 1011-1015. A bitmap 1020 is used to select which one of the sub-bands 1011-1015 is configured for SRS transmission. For example, if B4 is set to ‘1’, the sub-band 1015 is configured for SRS transmission and if B4 is set to ‘0’, the sub-band 1015 is not configured for SRS transmission; if B3 is set to ‘1’, the sub-band 1014 is configured for SRS transmission and if B3 is set to ‘0’, the sub-band 1014 is not configured for SRS transmission; ... if B0 is set to ‘1’, the sub-band 1011 is configured for SRS transmission and if B0 is set to ‘0’, the sub-band 1011 is not configured for SRS transmission.

It is to be understood that, the bitmap can be used in the partial sounding phase for indicating which ones of the sub-bands are configured for SRS transmission. For example, if all of the bits in the bitmap are set to ‘1’, it means that the partial sounding across frequency is disabled; and if one of the bits in the bitmap is set to ‘0’, it means that the partial sounding across frequency is enabled. Moreover, after the partial sounding phase, the network device 110 can use a similar bitmap to configure a subset of the sub-bands to the terminal device 120. As such, the terminal device 120 will transmit SRS with full RBs in the subset of the sub-bands.

In some embodiments, the order for the selected hops may be determined based on the above formula (3), (4), (5), (7) or (8) used for calculating the frequency position indices for SRS trasnmission. In some embodiments, each of the selected hops can be assigned with a relative index within the number of selected hops.

In some embodiments, more hops can be introduced for aperiodic SRS (AP-SRS). In some embodiments, the number of symbols for the AP-SRS resource may be based on the number of hops to cover the configured sounding bandwidth or based on the selected number of hops. In some embodiments, the aperiodic SRS frequency hopping may be across the SRS resources within the SRS resource set. In some embodiments, the number of sub-bands or hops for SRS transmission may be K. For example, K is a positive integer, and 2 ≤ K ≤ 68. In some embodiments, the number of SRS transmission hops in one SRS resource is L. For example, L is 2 or 4. In some embodiments, if K > L, the SRS frequency hopping may be performed across the SRS resources within the SRS resource set. For example, the quantity n_{SRS} counts the number of SRS transmissions across SRS resources. For the case of an SRS resource configured as aperiodic by the higher-layer parameter resourceType, it is given by n_{SRS} =

$$\left⌊{N}_{s y m b}^{S R S} / R\right⌋ ∗ i + \left⌊{l}^{′} / R\right⌋$$

(where l′ = 0, 1, ...

$${N}_{s y m b}^{S R S}$$

within the slot or the SRS resource set in which the

$${N}_{s y m b}^{S R S}$$

symbol SRS resource is transmitted. For example, the number of SRS resources within the SRS resource set may be P (where P is an integer and 1 ≤ P ≤ 4). For example, i is an integer and 0 ≤ i ≤ P. The quantity

$$R \leq {N}_{\text{symb}}^{\text{SRS}}$$

is the repetition factor given by the field repetitionFactor contained in the higher-layer parameter resourceMapping if configured, otherwise

$$R = {N}_{\text{symb}}^{\text{SRS}} .$$

For example, when n_{SRS} = K, the SRS transmission is ended in the SRS resource set. In some embodiments, for AP-SRS, the sounding bandwidth may be configured as N (for example, N is an integer and 4 ≤ N ≤ 272) and the sub-band for each hop may be configured as M (for example, M is an integer and 4 ≤ M ≤ 272), where N is an integer multiple of M. As such, the number of hops may be N/M.

In some embodiments, for persistent SRS or semi-persistent SRS, two levels of periodicity can be configured, which the first level of periodicity may indicate a time interval between two adjacent rounds of hops and the second level of periodicity may indicate a time interval between two adjacent hops within one round of hops. In some embodiments, the two levels of periodicity can be configured to the terminal device via RRC signaling.

FIG. 11 illustrates an example of such embodiments. As shown in FIG. 11, a sounding bandwidth 1110 is configured for SRS transmission, which is divided into 4 sub-bands. Two levels of periodicity 1140 and 1150 can be configured for SRS transmission. The first level of periodicity 1140 indicates a time interval between two adjacent rounds of hops 1120 and 1130. The second level of periodicity 1150 indicates a time interval between two adjacent hops 1111 and 1112 within one round of hops 1120 or 1130.

In some embodiments, if partial sounding across frequency is enabled, the value of the repetition factor R may be configured or assumed to be the same as the number of symbols for the SRS resource. That is, R = Nₛ, which means that there is no repetition for SRS in the event of partial frequency sounding.

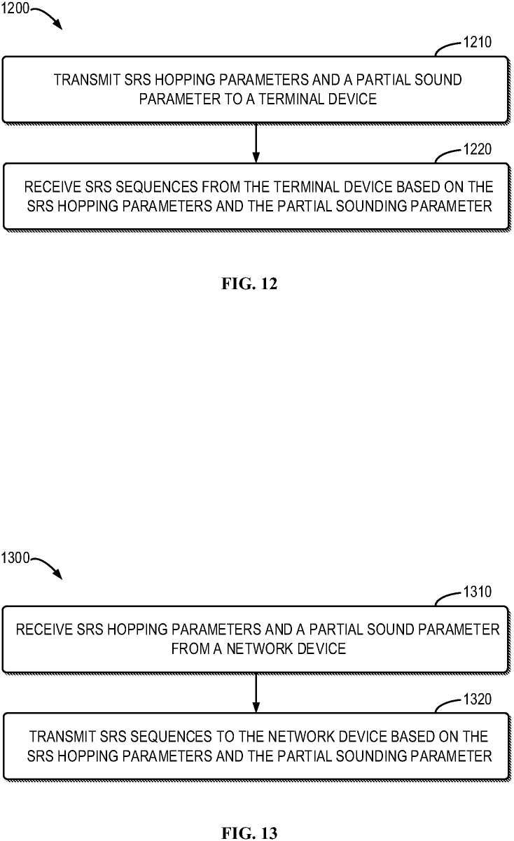

FIG. 12 illustrates a flowchart of an example method 1200 in accordance with some embodiments of the present disclosure. The method 1200 can be performed at the network device 110 as shown in FIG. 1. It is to be understood that the method 1200 may include additional blocks not shown and/or may omit some blocks as shown, and the scope of the present disclosure is not limited in this regard.

At block 1210, the network device 110 transmits, to the terminal device 120, SRS hopping parameters and a partial sounding parameter, where the SRS hopping parameters indicate a bandwidth configuration for SRS communication and the partial sounding parameter indicates whether partial sounding across frequency is enabled or not.

In some embodiments, the network device 110 transmits, to the terminal device 120, the SRS hopping parameters via RRC signaling.

In some embodiments, the network device 110 transmits, to the terminal device 120, the partial sounding parameter via any of RRC signaling, MAC CE and DCI.

At block 1220, the network device 110 receives SRS sequences from the terminal device 120 based on the SRS hopping parameters and the partial sounding parameter.

In some embodiments, the SRS hopping parameters indicate a frequency bandwidth for SRS communication. In response to the partial sounding parameter indicating that the partial sounding across frequency is enabled, the network device 110 receives the SRS sequences from the terminal device 120 over a part of the frequency bandwidth.

In some embodiments, the SRS hopping parameters indicate a band or sub-band comprising a number of resource blocks for SRS communication. In response to the partial sounding parameter indicating that the partial sounding across frequency is enabled, the network device 110 receives the SRS sequences from the terminal device 120 over a part of the resource blocks within the band or sub-band.

In some embodiments, the SRS hopping parameters indicate a frequency bandwidth for SRS communication and a first number of hops to cover the frequency bandwidth. In response to the partial sounding parameter indicating that the partial sounding across frequency is enabled, the network device 110 receives the SRS sequences from the terminal device 120 through a second number of hops, where the second number is less than the first number.

In some embodiments, the first number of hops respectively occupy the first number of sub-bands for SRS communication and each of the second number of hops is overlapped with at least one of the sub-bands.

In some embodiments, the first number of hops occupy a frequency bandwidth for SRS communication and the second number of hops do not exceed a range of the frequency bandwidth.

In some embodiments, the first number of hops occupy a frequency bandwidth for SRS communication and at least one of the second number of hops exceeds a range of the frequency bandwidth.

In some embodiments, in response to the partial sounding parameter indicating that the partial sounding across frequency is enabled, the network device 110 receives the SRS sequences generated based on an increased comb value from the terminal device 120.

FIG. 13 illustrates a flowchart of an example method 1300 in accordance with some embodiments of the present disclosure. The method 1300 can be performed at the terminal device 120 as shown in FIG. 1. It is to be understood that the method 1300 may include additional blocks not shown and/or may omit some blocks as shown, and the scope of the present disclosure is not limited in this regard.

At block 1310, the terminal device 120 receives, from the network device 110, SRS hopping parameters and a partial sounding parameter, where the SRS hopping parameters indicate a bandwidth configuration for SRS communication and the partial sounding parameter indicates whether partial sounding across frequency is enabled or not.

In some embodiments, the terminal device 120 receives, from the network device 110, the SRS hopping parameters via Radio Resource Control (RRC) signaling.

In some embodiments, the terminal device 120 receives, from the network device 110, the partial sounding parameter via any of RRC signaling, MAC CE and DCI.

At block 1320, the terminal device 120 transmits SRS sequences to the network device 110 based on the SRS hopping parameters and the partial sounding parameter.

In some embodiments, the SRS hopping parameters indicate a frequency bandwidth for SRS communication. In response to the partial sounding parameter indicating that the partial sounding across frequency is enabled, the terminal device 120 transmits the SRS sequences to the network device 110 over a part of the frequency bandwidth.

In some embodiments, the SRS hopping parameters indicate a band or sub-band comprising a number of resource blocks for SRS communication. In response to the partial sounding parameter indicating that the partial sounding across frequency is enabled, the terminal device 120 transmits the SRS sequences to the network device 110 over a part of the resource blocks within the band or sub-band.

In some embodiments, the SRS hopping parameters indicate a frequency bandwidth for SRS communication and a first number of hops to cover the frequency bandwidth. In response to the partial sounding parameter indicating that the partial sounding across frequency is enabled, the terminal device 120 transmits the SRS sequences to the network device 110 through a second number of hops, where the second number is less than the first number.

In some embodiments, the first number of hops respectively occupy the first number of sub-bands for SRS communication and each of the second number of hops is overlapped with at least one of the sub-bands.

In some embodiments, the first number of hops occupy a frequency bandwidth for SRS communication and the second number of hops do not exceed a range of the frequency bandwidth.

In some embodiments, the first number of hops occupy a frequency bandwidth for SRS communication and at least one of the second number of hops exceeds a range of the frequency bandwidth.

In some embodiments, in response to the partial sounding parameter indicating that the partial sounding across frequency is enabled, the terminal device 120 transmits the SRS sequences generated based on an increased comb value to the network device 110.

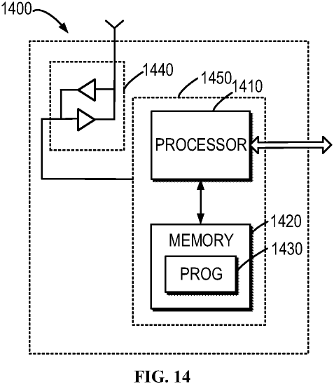

FIG. 14 is a simplified block diagram of a device 1400 that is suitable for implementing embodiments of the present disclosure. The device 1400 can be considered as a further example implementation of the network device 110 or the terminal device 120 as shown in FIG. 1. Accordingly, the device 1400 can be implemented at or as at least a part of the network device 110 or the terminal device 120.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 12 and/or FIG. 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
transmitting, from a network device, Sounding Reference Signal (SRS) hopping parameters and a partial sounding parameter to a terminal device,
wherein the SRS hopping parameters indicate a bandwidth configuration for SRS communication and the partial sounding parameter indicates whether partial sounding across frequency is enabled or not; and
receiving SRS sequences from the terminal device based on the SRS hopping parameters and the partial sounding parameter.

2. The method of claim 1, wherein the SRS hopping parameters indicate a frequency bandwidth for SRS communication, and receiving the SRS sequences comprises:
in response to the partial sounding parameter indicating that the partial sounding across frequency is enabled, receiving the SRS sequences from the terminal device over a part of the frequency bandwidth.

3. The method of claim 1, wherein the SRS hopping parameters indicate a band or sub-band comprising a number of resource blocks for SRS communication, and receiving the SRS sequences comprises:
in response to the partial sounding parameter indicating that the partial sounding across frequency is enabled, receiving the SRS sequences from the terminal device over a part of the resource blocks within the band or sub-band.

4. The method of claim 1, wherein the SRS hopping parameters indicate a frequency bandwidth for SRS communication and a first number of hops to cover the frequency bandwidth, and receiving the SRS sequences comprises:
in response to the partial sounding parameter indicating that the partial sounding across frequency is enabled, receiving the SRS sequences from the terminal device through a second number of hops, wherein the second number is less than the first number.

5. The method of claim 4, wherein:
the first number of hops respectively occupy the first number of sub-bands for SRS communication; and
each of the second number of hops is overlapped with at least one of the sub-bands.

6. The method of claim 4, wherein:
the first number of hops occupy a frequency bandwidth for SRS communication; and
the second number of hops do not exceed a range of the frequency bandwidth.

7. The method of claim 4, wherein:
the first number of hops occupy a frequency bandwidth for SRS communication; and
at least one of the second number of hops exceeds a range of the frequency bandwidth.

8. The method of claim 1, wherein receiving the SRS sequences comprises:
in response to the partial sounding parameter indicating that the partial sounding across frequency is enabled,
receiving the SRS sequences generated based on a comb value from the terminal device.

9. The method of claim 1, wherein transmitting the SRS hopping parameters comprises:
transmitting, to the terminal device, the SRS hopping parameters via Radio Resource Control (RRC) signaling.

10. The method of claim 1, wherein transmitting the partial sounding parameter comprises:
transmitting, to the terminal device, the partial sounding parameter via any of RRC signaling, Media Access Control (MAC) layer signaling and Downlink Control Information (DCI).

11. A method of communication, comprising:
receiving, at a terminal device and from a network device, Sounding Reference Signal (SRS) hopping parameters and a partial sounding parameter,
wherein the SRS hopping parameters indicate a bandwidth configuration for SRS communication and the partial sounding parameter indicates whether partial sounding across frequency is enabled or not; and
transmitting SRS sequences to the network device based on the SRS hopping parameters and the partial sounding parameter.

12. The method of claim 11, wherein the SRS hopping parameters indicate a frequency bandwidth for SRS communication, and transmitting the SRS sequences comprises:
in response to the partial sounding parameter indicating that the partial sounding across frequency is enabled, transmitting the SRS sequences to the network device over a part of the frequency bandwidth.

13. The method of claim 11, wherein the SRS hopping parameters indicate a band or sub-band comprising a number of resource blocks for SRS communication, and transmitting the SRS sequences comprises:
in response to the partial sounding parameter indicating that the partial sounding across frequency is enabled, transmitting the SRS sequences to the network device over a part of the resource blocks within the band or sub-band.

14. The method of claim 11, wherein the SRS hopping parameters indicate a frequency bandwidth for SRS communication and a first number of hops to cover the frequency bandwidth, and transmitting the SRS sequences comprises:
in response to the partial sounding parameter indicating that the partial sounding across frequency is enabled, transmitting the SRS sequences to the network device through a second number of hops, wherein the second number is less than the first number.

15. The method of claim 14, wherein:
the first number of hops respectively occupy the first number of sub-bands for SRS communication; and
each of the second number of hops is overlapped with at least one of the sub-bands.

16. The method of claim 14, wherein:
the first number of hops occupy a frequency bandwidth for SRS communication; and
the second number of hops do not exceed a range of the frequency bandwidth.

17. The method of claim 14, wherein:
the first number of hops occupy a frequency bandwidth for SRS communication; and
at least one of the second number of hops exceeds a range of the frequency bandwidth.

18. The method of claim 11, wherein transmitting the SRS sequences comprises:
in response to the partial sounding parameter indicating that the partial sounding across frequency is enabled, transmitting the SRS sequences generated based on a comb value to the network device.

19. The method of claim 11, wherein receiving the SRS hopping parameters comprises:
receiving, from the network device, the SRS hopping parameters via Radio Resource Control (RRC) signaling.

20. The method of claim 11, wherein receiving the partial sounding parameter comprises:
receiving, from the network device, the partial sounding parameter via any of RRC signaling, Media Access Control (MAC) layer signaling and Downlink Control Information (DCI).

21. A network device, comprising:
a processor; and
a memory coupled to the processor and storing instructions thereon, the instructions, when executed by the processor, causing the network device to perform the method according to any of claims 1 to 10.

22. A terminal device, comprising:
a processor; and
a memory coupled to the processor and storing instructions thereon, the instructions, when executed by the processor, causing the terminal device to perform the method according to any of claims 11 to 20.

23. A computer readable medium having instructions stored thereon, the instructions, when executed on at least one processor, causing the at least one processor to perform the method according to any of claims 1 to 10.

24. A computer readable medium having instructions stored thereon, the instructions, when executed on at least one processor, causing the at least one processor to perform the method according to any of claims 11 to 20.
